(19) United States
(12) Patent Application Publication
(10) Pub. No.: US 2013/0339736 A1
(43) Pub. Date: Dec. 19, 2013

(54) PERIODIC PLATFORM BASED WEB SESSION RE-VALIDATION

(71) Applicants: Alex Nayshtut, Gan Yavne,D, (IL); Omer Ben-Shalom, Rishon (IL)

(72) Inventors: Alex Nayshtut, Gan Yavne,D, (IL); Omer Ben-Shalom, Rishon (IL)

(21) Appl. No.: 13/527,371

(22) Filed: Jun. 19, 2012

(51) Int. Cl. H04L 9/32; H04L 9/00

(52) U.S. Cl. 713/170; 726/7; 713/168

(57) ABSTRACT

Systems, apparatus and methods for periodically validating the identity of two or more machines that have established a secure communication connection over a network. A client may initiate a secure communication session with a server by providing an identification certificate. Upon establishing a secure connection with the server, the client may periodically reaffirm its identity by sending a secure heartbeat message that includes a timestamp offset and a client identifier in order to keep the connection open. The server can require periodic receipt of the secure heartbeat message in order to maintain the secure communication session. The client identifier may include a code or value based on a unique physical attribute of the client. The timestamp offset may be calculated by the client based on a timestamp provided by the server.

### BACKGROUND

Existing industry standards that support strong authentication of communication sessions over networks, for example, transport layer security (TLS) or secure sockets layer (SSL) sessions are typically used for electronic-commerce (e-commerce) transactions and remote access to systems via a virtual private network (VPN). However, typical session authentication occurs only once at the initiation of a session. This can allow a malicious entity to hack or hijack a live session and gain unauthorized access to a system or data from an unauthorized machine by impersonating the originally authenticated machine.

One attempt to address the possibility of a hijacked session is the use of re-keying of encryption keys, for example the Internet Protocol Security (IPsec) protocols developed by the Internet Engineering Task Force; however, this only provides protection against an attempt to decrypt encoded traffic (e.g. crypto analysis).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram illustrating an example of a system with a client and server communicating over a network, according to an embodiment.

FIG. 2 is a flow diagram illustrating an example scheme for maintaining session security by a client, according to an embodiment.

FIG. 3 is a flow diagram illustrating an example scheme for maintaining session security by a server, according to an embodiment.

FIG. 4 is a dataflow diagram illustrating an example client-server interaction, according to an embodiment.

FIG. 5 is a block diagram illustrating an example machine upon which any one or more of the techniques discussed herein may be performed.

### DESCRIPTION OF THE EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Protecting a user's identity and personal data stored in remote clusters of networked computers (e.g., “cloud based storage” or “cloud computing”) creates a need for strong authentication that is rooted in hardware. Hardware-based authentication is regarded as a more effective approach than software-only authentication. Two-factor authentication using a one-time password (OTP) combines something the user knows (e.g., a username and password), and something the user has, for example, a token or key fob that produces a multi-digit number that is valid only for a short period of time. A combination of username, password, and an OTP can provide a more secure authentication mechanism than a username and password alone.

An example of hardware authentication may include a multi-digit number or code may be generated by an embedded processor or security device on the computer motherboard. In an embodiment, the security device is a controlled area of the chipset that is tamper-proof and may operate in isolation from the operating system for added security. Security algorithms included in software applications within the security device may perform the operations that link the computer to a validated site and ensure strong encryption.

However, authenticating a session between two machines (e.g., a server and a client) with one or more security mechanisms does not necessarily guarantee the continued security of the session. An authenticated session, even if encrypted, may remain open, or active, for minutes, hours, days or longer periods of time. A malicious third-party may be able to access and exploit the authentication data for the active session and impersonate one of the machines to gain access to the other while the session is active. For example, if a third-party can compromise a client machine and access the authentication data for a session the third-party may be able to impersonate the client and gain access to data on the server that would otherwise not be available to the third party.

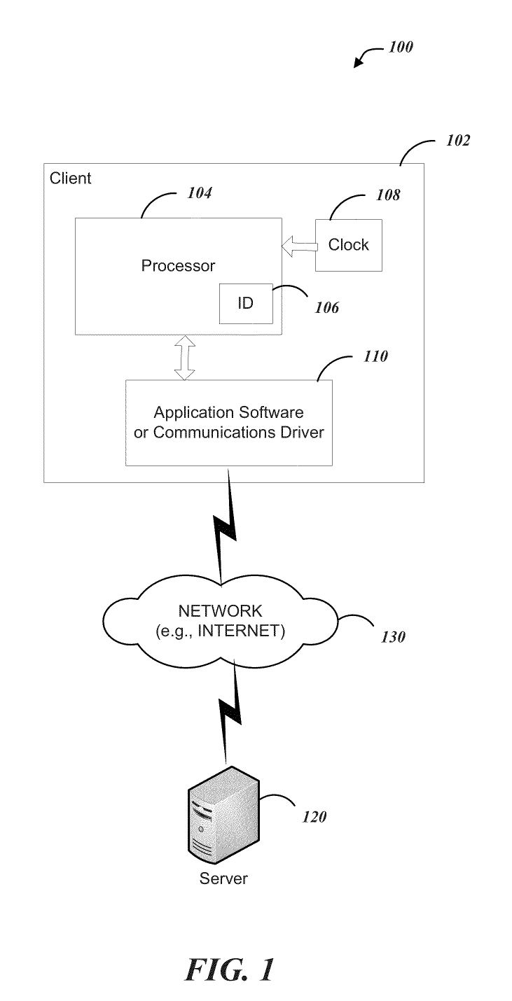

FIG. 1 is a block diagram illustrating an example of a system 100 with a client 102 and server 120 communicating with each other over a network 130. A client and server can be any combination of two or more machines, devices, processors, controllers, or other apparatus that may be configured to communicate securely over a network. The server 120 initially may validate the identity of the client 102 through any of a variety of typical authentication mechanisms, including, but not limited to, hardware authentication, software authentication, two-factor authentication, or any combination thereof. Validation can be accomplished using a client certificate that can be requested from the client 102, or through the use of a trusted directory or certificate authentication service to confirm the identity of the client 102 for the server 120.

An example approach to preventing third-party impersonation of the client 102 may include the server 120 periodically validating the identity of the client 102 by requiring the client 102 to generate and provide a periodic signed client-heartbeat message that the server 120 can use to verify that the identity of the client 102 has not been compromised. A signed client-heartbeat message may include information related to a physical attribute of the client 102 that cannot be identified for reproduction and impersonation by a third-party.

The client 102 may include a processor 104 that includes a unique identifier 106 embedded in a processor 104 that may be used in combination with a timestamp or other data to generate a unique session credential. The generation of a unique session credential may include a unique physical attribute of an individual client machine, such as a one-time password generated through the use of the unique identifier, alone or as the result of a process stored in the processor that may alter a unique identifier inside the processor. A secure chipset located in the client 102 and coupled to the processor 104 may also provide a unique session credential or process that may be utilized to combine information in the processor to generate the unique session credential.

In addition to a unique identifier 106, timestamp data can be based on information received from a clock 108, or from data received from the network 130. A unique identifier may be included in a separate security device (not depicted), that may be coupled to the processor 104, in the client 102. The timestamp data and unique identifier may be combined to create a unique session credential alone, or in combination with information communicated between the client 102 and the server 120. The unique session credential can be communicated to a software application 110 that is in communication with the server 120, or utilized by a device driver, toolkit, or other software to manage the security of a communication session. The unique session credential may be updated periodically with new or updated timestamp information for each signed client-heartbeat message that is communicated between the client 102 and the server 120.

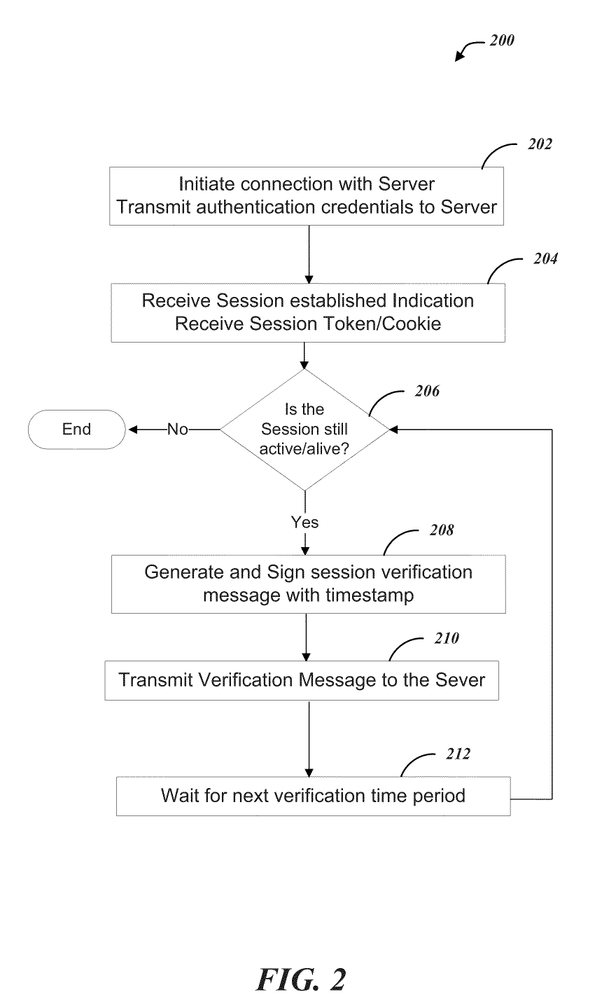

Referring to FIG. 2, an example scheme 200 for maintaining session security by a client and a server may include at 202, initiation of a connection with the server by the client and the client providing the server with identification credentials. In response to a session creation request the server will attempt to authenticate the client and create a session ID and token (e.g., a secure cookie for use with an encrypted session). Upon successful identification of the client by the server, at 204 the client may receive an indication that a session was successfully established. A successfully established session may be indicated by the receipt of a secure cookie or token from the server at the client. The secure cookie or token may contain a timestamp or other data from the server that may be used to generate a subsequent signed client-heartbeat message.

In order to maintain the security of the session, at 206 the client will periodically check to determine if the session with the server should be maintained and if the session is still active send the server an identifying signature, for example, the session ID or timestamp provided by the processor at the client. If the session is still alive, at 208 the client can generate and sign a session verification heartbeat message. The verification heartbeat message can include a unique identifier related to the client hardware, and a timestamp or offset related to the session. An initial timestamp can be registered during the session initiation 202 or derived at 204 from the secure cookie or token.

At 210, the verification heartbeat message can be transmitted to the server, thereby confirming the identity of the client to the server and maintaining the session connection.

At 212, the client waits before sending another heartbeat verification message. In an embodiment, the client waits for a predetermined amount of time before transmitting the next heartbeat verification message. The amount of time may be configured by a user. The amount of time between heartbeat verification messages can be configured by a user, set by the client in response to information contained in the secure cookie or token that was received at the initiation of the session, or configured to comply with a security policy or protocol standard. In another embodiment, the client waits until it receives a session identity confirmation request message from the server. The session identity confirmation request message is a message from the server requesting that the client re-validate its identity.

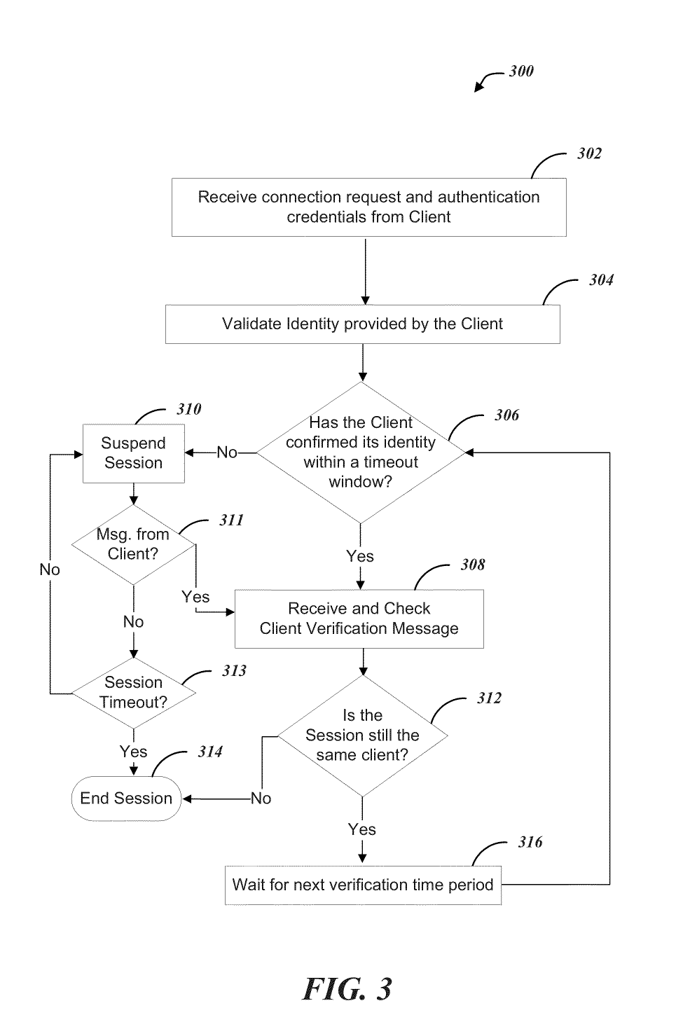

Referring to FIG. 3, an example scheme 300 for maintaining session security by a server may include at 302 receiving a connection request, and client credentials or identity information. At 304, the server may validate the identity provided by the client with information local to the server, or the server may contact a remote server or other service to validate the authenticity of the client's credentials.

At 306, the server may check to determine if a client as confirmed its identity for a session within a predetermined timeout window. If the server receives a verification heartbeat message, at 308 the server will check the identity and timestamp of the message. The server may validate that the timestamp is increasing consistently within a reasonable maximum drift. In an example, the drift may be on the order of a few seconds, e.g., 1-4 seconds, in order to accommodate the time necessary for transfer of the message through a network or minor differences between the clocks on the client and the server. The drift time allowance may be reduced in order to increase security, or increased to accommodate slow or intermittent session connections.

If the heartbeat is not received and accepted within the time window, the server may disconnect the session, or at 310 accept that the session is ‘dormant’ and suspend the session. In a suspended session the server does not allow or accept any traffic from the client until the next ‘heartbeat’ is received and accepted. If, at 311, the server receives a verification heartbeat message, at 308 the server will check the identity and timestamp of the message. The session may be allowed to remain suspended or in hibernation for a period of minutes or hours until a final session timeout, at 313, causes the session to be disconnected.

At 312, the sever may check if the identity of the client received in the verification heartbeat message matches the client identity, and if the appropriate timestamp or offset, of the original client associated with the session is included with the verification heartbeat message. If the client identification or timestamp data do not match, or are outside of an acceptable margin of error, at 314 the session is ended. If the client identification or timestamp data do match, and are within an acceptable margin of error, at 316 the server waits for the next verification time period.

A result of this process is that the client may be able to send secure heartbeat messages to the server during the session lifetime. Repeated or periodic confirmations of the identity of the client or server may increase the security value of the session communication and integrity of the communicating machines, because even if a third-party attacker manages to hijack the session key, the attacker cannot use it for more than the duration of a single heartbeat period without having to re-validate the connection. The use of a secure identity module or a unique processor identifier that may store information, (e.g., attestation keys) increases the difficulty of compromising a secure session. An additional advantage of this process is that the increased security can be achieved without any direct user involvement and not impacting the overall user experience with the secure application.

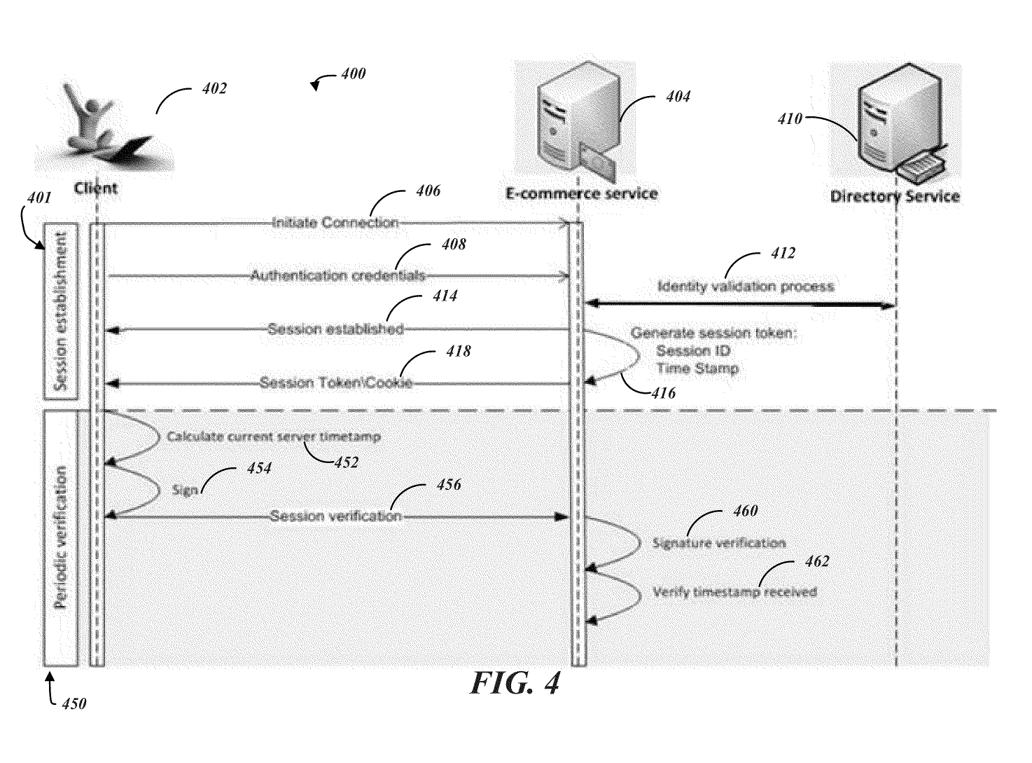

FIG. 4 illustrates a flow diagram of an example client-server interaction 400. The client-server interaction 400 may include or support any of a variety of typical security protocols, including, but not limited to, transport layer security (TLS), secure sockets layer (SSL). For additional information, the Internet Engineering Task Force (IETF) has prepared version 1.2 of the TLS protocol in RFC 5246 (request for comments 5246). The client-server interaction 400 may include or support any of a variety of application layer protocols, including, but not limited to, Hypertext Transfer Protocol (HTTP), File Transfer Protocol (FTP), Simple Mail Transfer Protocol (SMTP), and Extensible Messaging and Presence Protocol (XMPP).

At 401, in order to establish a secure network connection, a client 402 may request a connection with a server 404, for example an e-commerce service such as a banking website or other service where secure communication is desired, by sending an initiate connection request 406. The client-server interaction 400 may also be utilized with the establishment of a virtual private network (VPN) between two machines. In an example, the client 402 may initially provide authentication credentials 408, or wait for the server 404 to request credentials that identify the client 402. In the initiate connection request 406 the client 402 may specify a supported communication protocol version, a random number for use in establishing encrypted communication, or suggested encryption or compression methods.

The server 404 may attempt to validate any authentication credentials 408 provided by the client 402 with a directory service 410. A client identity validation process 412 may include sending all, or a portion, of the authentication credential 408 provided by the client 402 to the directory service 410. The directory service 410 may provide a confirmation or rejection of the validity of the authentication credential 408 to the server 404. The server 404 may also validate the authentication credential 408 provided by the client 402 without contacting the directory service 410, or by utilizing an authentication service that is internal to the server 404. Upon completion of the validation process 412, the server 404 may notify the client 402 that a session is established 414.

A server 404 that is establishing a secure connection with a client 402, after the validation of the identity of the client 402, may, at 416, generate a session token that may include a session ID and a time stamp. The session token may be embodied as a secure cookie, or any of a variety digital certificates that can be utilized to confirm the establishment of a secure connection between the client 402 and the server 404.

The client 402, in response to receiving a session token containing a session ID and a timestamp that establishes a session, at 450, may perform a periodic verification of the session. At 452, the client 402 may calculate a current server timestamp based on the time stamp information that was received from the server 404 during the session establishment 401. At 454, the client 402 may sign or encrypt the current server timestamp data in a manner that confirms the identity of the client 402 to the server 404.

At 456, the client 402 may transmit the session verification information to the server 404, prior to the expiration of a timeout event at the server 404 that would cause the server 404 to release or close the session. Upon receipt of the session verification information from the client 402, at 460, the server 404 may verify that the signature originated from the client 402 that was previously associated with the session ID. At 462, the server 404 may verify the timestamp information included in the session verification information. The server 404 may acknowledge the receipt of the session verification information to the client 402, or the client 402 may infer that the session verification information was successfully received and authenticated by the server 404 through continued transmission of data between the server 404 and the client 402 over the session.

The periodic verification of the session 450 may be repeated periodically throughout the entire lifetime of the session between the client 402 and the server 404. If the server 404 determines that an unauthorized attempt to access data on the server 404, as indicated by a invalid verification signature or invalid server timestamp, the server 404 may terminate the session. After the termination of a session the client 402 may attempt, at 401, to establish a new session.

The session may also be periodically validated by the server 404 transmitting a verification message to the client 402. The sever 404 and client 402 may also each request validation of the other at any randomly selected period of time during the lifetime of the session. The server 404 or client 402 may transmit verification messages to the other without requiring input or interaction with a user, thereby providing for secure periodic re-authentication of a session between two machines with minimal user intervention.

In another example, the server 404 can establish an identity of the server 404 at the client 402. In a manner similar to the client 402 regularly transmitting a heartbeat message to the server 402, the server 404 may transmit a heartbeat message to the client 402. The heartbeat message validating the identity of the server 404 at the client 402. In an example, the heartbeat message from the server 402 can act as a request message to the client 402, prompting the client 402 to confirm its identity with the server 404.

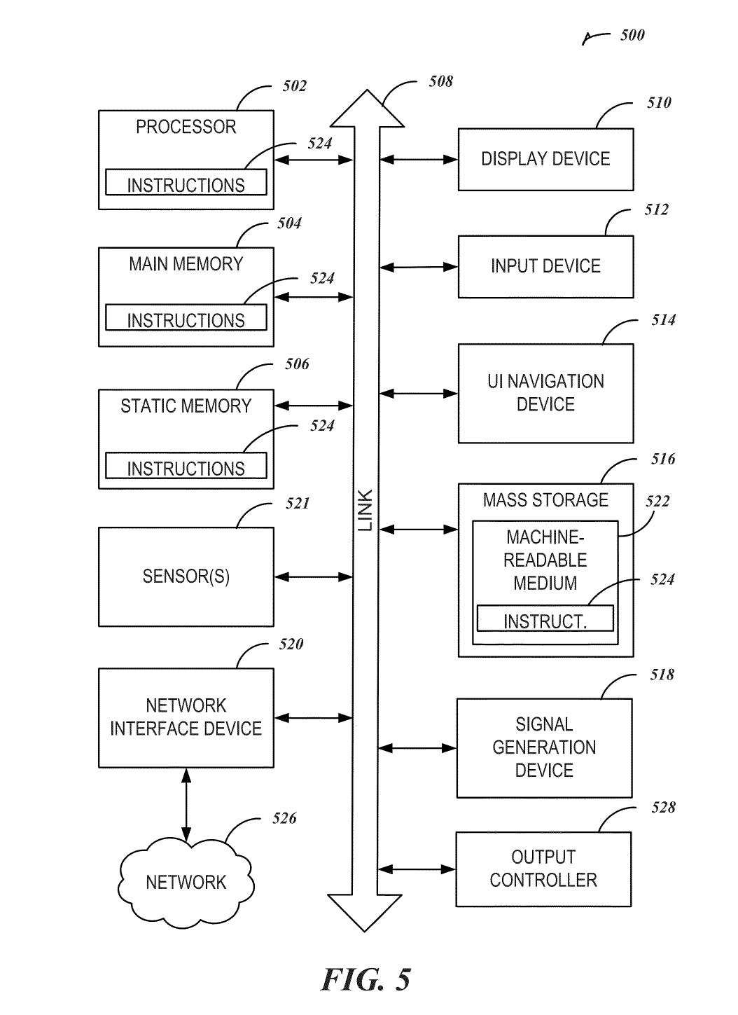

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a processing unit, a graphics processing unit (GPU), a hardware processor core, or any combination thereof), a main memory 504, and a static memory 506, some or all of which may communicate with each other via a link 508 (e.g., a bus, link, interconnect, or the like). The machine 500 may further include a display device 510, an input device 512 (e.g., a keyboard), and a user interface (UI) navigation device 514 (e.g., a mouse). In an example, the display device 510, input device 512, and UI navigation device 514 may be a touch screen display. The machine 500 may additionally include a mass storage (e.g., drive unit) 516, a signal generation device 518 (e.g., a speaker), a network interface device 520, and one or more sensors 521, such as a global positioning system (GPS) sensor, camera, video recorder, compass, accelerometer, or other sensor. The machine 500 may include an output controller 528, such as a serial (e.g., universal serial bus (USB), parallel, or other wired or wireless (e.g., infrared (IR)) connection to communicate or control one or more peripheral devices (e.g., a printer, card reader, etc.).

The mass storage 516 may include a machine-readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the mass storage 516 may constitute machine readable media.

While the machine-readable medium 522 is illustrated as a single medium, the term “machine readable medium” may include a single medium or multiple media (e.g., a centralized or distributed database, and/or associated caches and servers) that configured to store the one or more instructions 524. The term “machine-readable medium” may include any tangible medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### VARIOUS NOTES & EXAMPLES

Specifics in the examples may be used anywhere in one or more embodiments.

Example 1 can include subject matter (such as an apparatus, a method, a means for performing acts, or a machine readable medium including instructions that, when performed by the machine, that can cause the machine to perform acts), such as at least one machine readable medium comprising a plurality of instructions that in response to being executed on a computing device, can cause the computing device to: authenticate a communication session between a first machine and a second machine; establish an identity of the first machine with the second machine; and periodically validate the identity of the first machine with the second machine during the communication session.

Example 2 can include, or can optionally be combined with the subject matter of Example 1, to optionally include a plurality of instructions that in response to being executed on the computing device, can cause the computing device to: generate the identity of the first machine from a unique physical attribute of the first machine.

Example 3 can include, or can optionally be combined with the subject matter of Examples 1 or 2, to optionally include a plurality of instructions that in response to being executed on the computing device, can cause the computing device to: generate the identity of the first machine from a unique identifier obtained from a processor of the first machine.

Example 4 can include, or can optionally be combined with the subject matter of Examples 1, 2 or 3, to optionally include a plurality of instructions that in response to being executed on a computing device, can cause the computing device to: transmit a heartbeat message from the first machine to the second machine, the heartbeat message validating the identity of the first machine.

Example 5 can include, or can optionally be combined with the subject matter of Example 4, to optionally include wherein the heartbeat message includes a unique identifier associated with the first machine, and a timestamp.

Example 6 can include, or can optionally be combined with the subject matter of Examples 1 through 5, to optionally include wherein the communication session is encrypted.

Example 7 can include, or can optionally be combined with the subject matter of Examples 1 through 6, to optionally include wherein the second machine suspends the communication session in response to a failure to receive a message confirming the identity of the first machine within a predetermined period of time.

Example 8 can include, or can optionally be combined with the subject matter of Examples 1 through 7, to optionally include a plurality of instructions that in response to being executed on a computing device, can cause the computing device to: close the communication session upon receipt of a message appearing to be from the second machine that fails to confirm the identity of the first machine.

Example 9 can include, or can optionally be combined with the subject matter of Examples 1 through 8, to optionally include a plurality of instructions that in response to being executed on a computing device, can cause the computing device to: establish an identity of the second machine at the first machine; and transmit a heartbeat message from the second machine to the first machine, the heartbeat message validating the identity of the second machine.

Example 10 can include subject matter (such as an apparatus, a method, a means for performing acts, or a machine readable medium including instructions that, when performed by the machine, that can cause the machine to perform acts), such as at least one machine readable medium comprising a method of validating communication initiated by a remote device comprising: receiving a request, at a server, to establish a communication session from the remote device; in response to the request, validating an identity of the remote device at the server; waiting a predetermined period of time for the receipt of a message confirming the identity of the remote device in response to the validation of the identity of the remote device; and re-validating the identity of the remote device upon receipt of the message confirming the identity of the remote device.

Example 11 can include, or can optionally be combined with the subject matter of Example 10, to optionally include wherein the identity of the remote device includes a unique physical attribute of the remote device.

Example 12 can include, or can optionally be combined with the subject matter of Examples 10 or 11 to optionally include wherein the identity of the remote device includes a unique identifier obtained from a processor of the remote device.

Example 13 can include, or can optionally be combined with the subject matter of Examples 10 through 12, to optionally include wherein the message confirming the identity of the remote device includes a unique identifier obtained from a processor of the remote device and a timestamp.

Example 14 can include, or can optionally be combined with the subject matter of Examples 10 through 13, to optionally include suspending the communication session in response to a failure to receive the message confirming the identity of the remote device in the predetermined period of time.

Example 15 can include, or can optionally be combined with the subject matter of Examples 10 through 14, to optionally include closing the communication session upon receipt of a message appearing to be from the remote device that fails to confirm the identity of the remote device.

Example 16 can include, or can optionally be combined with the subject matter of Examples 10 through 15, to optionally include wherein the communication session is encrypted.

Example 17 can include an apparatus for validating communication initiated by a remote device, configured to perform the methods disclosed in any one of Examples 10 through 16.

Example 18 can include subject matter (such as an apparatus, a method, a means for performing acts, or a machine readable medium including instructions that, when performed by the machine, that can cause the machine to perform acts), such as a method of securing communication with a remote device comprising: initiating a communication request, at a first machine, to establish a communication session with the remote device; providing a unique identity to the remote device; receiving a confirmation of the establishment of the communication session; waiting a predetermined period of time; and transmitting an identity confirmation to the remote device periodically.

Example 19 can include, or can optionally be combined with the subject matter of Example 18, to optionally include wherein the unique identity of the first machine includes a unique physical attribute of the first machine.

Example 20 can include, or can optionally be combined with the subject matter of Examples 18 or 19, to optionally include wherein the unique identity of the first machine includes a unique identifier obtained from a processor of the first machine.

Example 21 can include, or can optionally be combined with the subject matter of Examples 18 through 20, to optionally include transmitting a timestamp and the identity confirmation to the remote device periodically.

Example 22 can include, or can optionally be combined with the subject matter of Examples 18 through 21, to optionally include wherein the communication session is encrypted.

Example 23 can include an apparatus for securing communication with a remote device, configured to perform the method described in any one of Examples 18 to 22.

Example 24 can include a communications device arranged to perform the method described in any one of Examples 10 through 22.

Example 25 can include at least one machine readable medium comprising a plurality of instructions that in response to being executed on a computing device, cause the computing device to carry out a method described in any one of Examples 10 through 22.

Example 26, can include subject matter (such as an apparatus, a method, a means for performing acts, or a machine readable medium including instructions that, when performed by the machine, that can cause the machine to perform acts), such as a secure communication system comprising: a first processor including a unique identifier, the first processor being capable of communication over a network; and a second processor coupled to the network, the second processor being capable of receiving the unique identifier from the first processor, and configured to communicate with the first processor for a period of time after the receipt of the unique identifier, with the first processor being configured to periodically provide the unique identifier to the second processor at least once during the period of time.

Example 27 can include, or can optionally be combined with the subject matter of Example 26, to optionally include wherein the unique identifier of the first processor includes a unique physical attribute of the first processor.

Example 28 can include, or can optionally be combined with the subject matter of Examples 26 or 27, to optionally include wherein the second processor is configured to stop communication with the first processor in response to a failure to receive the unique identifier from the first processor in the period of time.

Example 29 can include, or can optionally be combined with the subject matter of Examples 26, 27 or 28, to optionally include wherein the communication over the network between the first processor and the second processor is encrypted.

Each of these non-limiting examples can stand on its own, or can be combined in any permutation or combination with any one or more of the other examples.

1. At least one machine readable medium comprising a plurality of instructions that in response to being executed on a computing device, can cause the computing device to:
authenticate a communication session between a first machine and a second machine;
establish an identity of the first machine with the second machine; and
periodically validate the identity of the first machine with the second machine during the communication session.

2. The at least one machine readable medium as recited in claim 1, comprising a plurality of instructions that in response to being executed on the computing device, can cause the computing device to:
generate the identity of the first machine from a unique physical attribute of the first machine.

3. The at least one machine readable medium as recited in claim 1, comprising a plurality of instructions that in response to being executed on the computing device, can cause the computing device to:
generate the identity of the first machine from a unique identifier obtained from a processor of the first machine.

4. The at least one machine readable medium as recited in claim 1, comprising a plurality of instructions that in response to being executed on a computing device, can cause the computing device to:
transmit a heartbeat message from the first machine to the second machine, the heartbeat message validating the identity of the first machine.

5. The at least one machine readable medium as recited in claim 4, wherein the heartbeat message includes a unique identifier associated with the first machine, and a timestamp.

6. The at least one machine readable medium as recited in claim 1, wherein the communication session is encrypted.

7. The at least one machine readable medium as recited in claim 1, wherein the second machine suspends the communication session in response to a failure to receive a message confirming the identity of the first machine within a predetermined period of time.

8. The at least one machine readable medium as recited in claim 1, comprising a plurality of instructions that in response to being executed on a computing device, can cause the computing device to:
close the communication session upon receipt of a message appearing to be from the second machine that fails to confirm the identity of the first machine.

9. The at least one machine readable medium as recited in claim 1, comprising a plurality of instructions that in response to being executed on a computing device, can cause the computing device to:
establish an identity of the second machine at the first machine; and
transmit a heartbeat message from the second machine to the first machine, the heartbeat message validating the identity of the second machine.

10. A method of validating communication initiated by a remote device comprising:
receiving a request, at a server, to establish an encrypted communication session from the remote device;
in response to the request, validating an identity of the remote device at the server;
waiting a predetermined period of time for the receipt of a message confirming the identity of the remote device in response to the validation of the identity of the remote device; and
re-validating the identity of the remote device upon receipt of the message confirming the identity of the remote device.

11. The method of claim 10, wherein the identity of the remote device includes a unique physical attribute of the remote device.

12. The method of claim 10, wherein the identity of the remote device includes a unique identifier obtained from a processor of the remote device.

13. The method of claim 10, wherein the message confirming the identity of the remote device includes a unique identifier obtained from a processor of the remote device and a timestamp.

14. The method of claim 10, comprising
suspending the encrypted communication session in response to a failure to receive the message confirming the identity of the remote device in the predetermined period of time.

15. The method of claim 10, comprising:
closing the encrypted communication session upon receipt of a message appearing to be from the remote device that fails to confirm the identity of the remote device.

16. A method of securing communication with a remote device comprising:
initiating a communication request, at a first machine, to establish a secure communication session with the remote device;
providing a unique identity to the remote device;
receiving a confirmation of the establishment of the secure communication session;
waiting a predetermined period of time; and
transmitting an identity confirmation to the remote device periodically.

17. The method of claim 16, wherein the unique identity of the first machine includes a unique physical attribute of the first machine.

18. The method of claim 16, wherein the unique identity of the first machine includes a unique identifier obtained from a processor of the first machine.

19. The method of claim 16, comprising: transmitting a timestamp and the identity confirmation to the remote device periodically.

20. The method of claims 16, wherein the secure communication session is encrypted.

21. A secure communication system comprising:
a first processor including a unique identifier, the first processor being capable of secure communication over a network; and
a second processor coupled to the network, the second processor being capable of receiving the unique identifier from the first processor, and configured to communicate with the first processor for a period of time after the receipt of the unique identifier, with the first processor being configured to periodically provide the unique identifier to the second processor at least once during the period of time;
wherein the communication over the network between the first processor and the second processor is encrypted.

22. The system of claim 21, wherein the unique identifier of the first processor includes a unique physical attribute of the first processor.

23. The system of claim 21, wherein the second processor is configured to stop communication with the first processor in response to a failure to receive the unique identifier from the first processor in the period of time.
